(19) United States
(12) Patent Application Publication
(10) Pub. No.: US 2026/0213378 A1
(43) Pub. Date: Jul. 23, 2026

(54) SECONDARY BATTERY

(71) Applicant: HONDA MOTOR CO., LTD., Tokyo (JP)

(72) Inventor: Tatsuya Iwakura, Saitama (JP)

(73) Assignee: HONDA MOTOR CO., LTD., Tokyo (JP)

(21) Appl. No.: 19/449,468

(22) Filed: Jan. 15, 2026

(30) Foreign Application Priority Data
Jan. 17, 2025 (JP) 2025-006888

(51) Int. Cl. H01M 50/583; H01M 50/54; H01M 50/581

(52) U.S. Cl. CPC H01M 50/583; H01M 50/54; H01M 50/581; H01M 2200/106

(57) ABSTRACT

A secondary battery has an electrode laminate in which a plurality of positive electrode layers and a plurality of negative electrode layers are laminated via an electrolyte layer, and a sheath that accommodates the electrode laminate. A tab lead protruding from the sheath is joined to a current collector of the positive electrode layers and a current collector of the negative electrode layers. A resin member configured to cut off an overcurrent according to an increase in temperature is provided between the tab lead and at least one of the current collector of the positive electrode layers or the current collector of the negative electrode layers.

### CROSS-REFERENCE TO RELATED APPLICATIONS

This application is based on and claims priority under 35 USC 119 from Japanese Patent Application No. 2025-006888 filed on Jan. 17, 2025, the entire content of which is incorporated herein by reference.

### TECHNICAL FIELD

The present disclosure relates to a secondary battery.

### BACKGROUND ART

In recent years, researches and developments have been conducted on a secondary battery which contributes to improvement in energy efficiency in order to allow more people to have access to affordable, reliable, sustainable and advanced energy.

For example, JP6973489B describes a lithium ion secondary battery of a lamination

film type including a flat electrode body to which a positive electrode lead and a negative

electrode lead are attached, an electrolytic solution, and a film-shaped exterior material that accommodates the electrode body and the electrolytic solution.

As research and development related to a secondary battery, research and development have been performed to ensure safety by appropriately reducing charging and discharging of the secondary battery when an abnormality such as thermal runaway occurs. It is required to consider in terms of a structure of the secondary battery regarding reducing of charging and discharging at the time of such an abnormality.

### SUMMARY OF INVENTION

The present disclosure provides a secondary battery capable of appropriately reducing charging and discharging at the time of abnormality.

An aspect of the present disclosure is a secondary battery having:
an electrode laminate in which a plurality of positive electrode layers and a plurality of negative electrode layers are laminated via an electrolyte layer; and
a sheath that accommodates the electrode laminate, in which
a tab lead protruding from the sheath is joined to a current collector of the positive electrode layers and a current collector of the negative electrode layers, and
a resin member configured to cut off an overcurrent according to an increase in temperature is provided between the tab lead and at least one of the current collector of the positive electrode layers or the current collector of the negative electrode layers.

According to the aspect of the present disclosure, since the resin member capable of cutting off an overcurrent in response to an increase in temperature is provided between the current collector and the tab lead, it is possible to cut off an overcurrent flowing due to charging and discharging of the secondary battery, for example, when a temperature of the secondary battery becomes high. Therefore, safety of the secondary battery can be improved.

### BRIEF DESCRIPTION OF DRAWINGS

Exemplary embodiment(s) of the present invention will be described in detail based on the following figures, wherein:

FIG. 1 is a schematic cross-sectional view illustrating an internal structure of a secondary battery 1 according to an embodiment of the present disclosure;

FIG. 2 is an enlarged cross-sectional view of a vicinity of a positive electrode tab lead 4; and

FIG. 3 illustrates the vicinity of the positive electrode tab lead 4 as viewed in a Z-axis direction.

### DESCRIPTION OF EMBODIMENTS

Hereinafter, a secondary battery according to an embodiment of the present disclosure will be described with reference to the accompanying drawings. In the following description, directions of arrows illustrated in the drawings are referred to as an X-axis direction, a Y-axis direction, and a Z-axis direction, respectively.

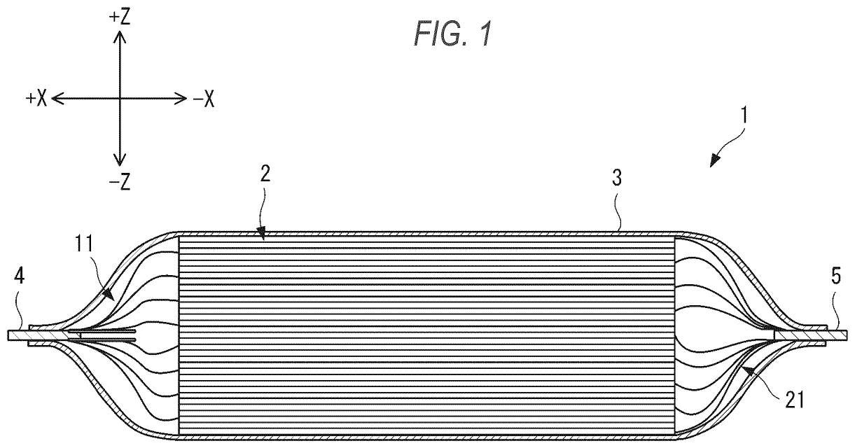

FIG. 1 is a schematic cross-sectional view illustrating an internal structure of a secondary battery 1. The secondary battery 1 is implemented as, for example, a solid-state battery having a solid electrolyte. The secondary battery 1 is not particularly limited, and

examples thereof include a lithium ion secondary battery and a lithium metal secondary battery.

The secondary battery 1 includes an electrode laminate 2 in which a plurality of positive electrode layers 10 and a plurality of negative electrode layers 20 are laminated via a solid electrolyte layer 30, a sheath 3 that accommodates the electrode laminate 2, and a positive electrode tab lead 4 and a negative electrode tab lead 5 protruding from the sheath 3. The secondary battery 1 has a shape elongated in the X-axis direction, and the plurality of positive electrode layers 10, the plurality of negative electrode layers 20, and the solid electrolyte layer 30 are laminated in the Z-axis direction.

The sheath 3 is, for example, a lamination film, and seals the entire electrode laminate 2. As the lamination film, a laminated film having a three-layer structure in which an inner resin layer, a metal layer, and an outer resin layer are laminated in this order from the inside can be used. As a material for the inner resin layer and the outer resin layer, for example, a thermoplastic resin such as polyethylene terephthalate (PET), polyamide (nylon), or polypropylene (PP) can be used. For example, aluminum can be used as the material for the metal layer.

The positive electrode tab lead 4 and the negative electrode tab lead 5 are provided at two ends in a longitudinal direction (X-axis direction) of the secondary battery 1, and a part thereof protrude from the inside to an outside of the sheath 3. The positive electrode tab lead 4 and the negative electrode tab lead 5 are conductive plate-shaped members. In the example illustrated here, the positive electrode tab lead 4 is provided on a +X side, and the negative electrode tab lead 5 is provided on a −X side. Both the positive electrode tab lead 4 and the negative electrode tab lead 5 may be provided on the +X side or may be provided on the −X side.

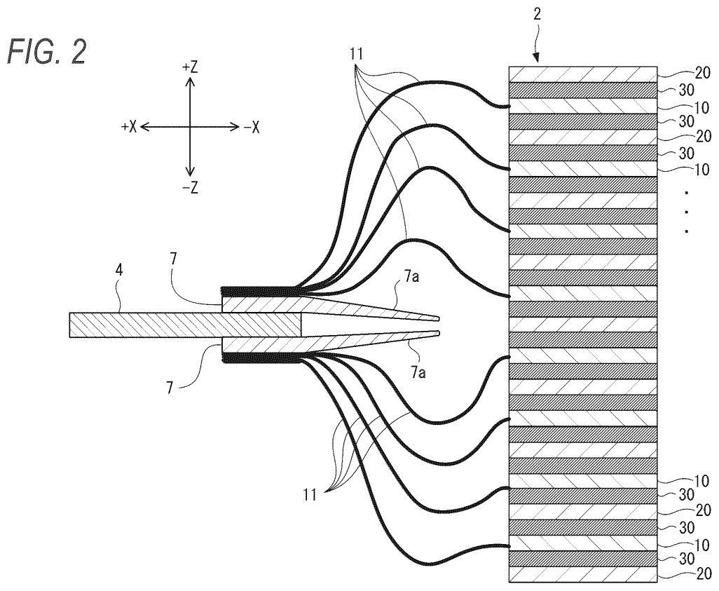

FIG. 2 is an enlarged cross-sectional view of a vicinity of the positive electrode tab lead 4. In FIG. 2, the sheath 3 is not illustrated. First, configurations of the positive electrode

layer 10, the negative electrode layer 20, and the solid electrolyte layer 30 in the electrode

laminate 2 will be described.

The positive electrode layer 10 includes a positive electrode current collector 11 and a positive electrode active material layer laminated on each other. The positive electrode current collector 11 extends from the electrode laminate 2 to the +X side, and is joined and electrically connected to the positive electrode tab lead 4. The positive electrode tab lead 4 is formed of a similar material (described later) as the positive electrode current collector 11.

The positive electrode current collector 11 has a function of collecting current from the positive electrode active material layer. The positive electrode current collector 11 preferably includes at least one material having high conductivity. Examples of a highly conductive material include aluminum, an aluminum alloy, stainless steel, nickel, iron, and titanium. Examples of a shape of the positive electrode current collector 11 include a foil shape, a thin plate shape, a mesh shape, a nonwoven fabric shape, and a foam shape. A surface of the positive electrode current collector 11 may be roughened in order to enhance adhesion to the positive electrode active material layer.

The positive electrode active material layer contains, for example, a positive electrode active material and a solid electrolyte. The positive electrode active material layer is formed by applying a positive electrode slurry, which is generated by kneading the positive electrode active material and the solid electrolyte together with a dispersion medium, to the positive electrode current collector 11, and drying the positive electrode slurry. Here, the dispersion medium includes a conductive assistant, a binder, and a solvent.

The positive electrode active material can be similar as that used for a positive electrode of a general solid-state battery. Examples of the positive electrode active material include lithium-cobalt composite oxide, lithium-nickel composite oxide, lithium-nickel-cobalt composite oxide, lithium-nickel-manganese composite oxide, lithium-nickel-cobalt-manganese composite oxide, and lithium-nickel-cobalt-aluminum composite oxide. Specific examples of the positive electrode active material include LiCoO₂ and LiNiₚMn_{q}CoᵣO₂ (p+q+r=1), LiNiₚAl_{q}CoᵣO₂ (p+q+r=1). The positive electrode active material may be a material containing a metal element such as Cr, Fe, V, Mg, Ca, Na, Ti, Zr, Nb, Mo, W, Cu, Zn, Ga, In, Sn, La, and Ce.

The solid electrolyte contained in the positive electrode active material layer can be similar as that used in a general solid-state battery, and examples thereof include a similar solid electrolyte as a solid electrolyte (described later) contained in the solid electrolyte layer 30.

The conductive assistant contained in the dispersion medium can be similar as that used in a general solid-state battery, and examples thereof include carbon black, carbon nanotubes, graphene, and graphite particles.

The binder contained in the dispersion medium can be similar as that used in a general solid-state battery, and examples thereof include polyvinylidene fluoride (PVDF), polymethyl methacrylate (PMMA), polyisobutene (PIB), styrene-butadiene rubber (SBR), polyethylene-vinyl acetate copolymer (PEVA), nitrile rubber (NBR), and hydrogenated nitrile rubber (HNBR).

The solvent contained in the dispersion medium can be similar as that used in a

general solid-state battery, and examples thereof include an organic solvent such as N-methyl-2-pyrrolidone (NMP), toluene, butyl butyrate, or alcohol, or water.

The negative electrode layer 20 includes a negative electrode current collector 21 and a negative electrode active material layer laminated on each other. The negative electrode current collector 21 extends from the electrode laminate 2 to the −X side, and is joined and electrically connected to the negative electrode tab lead 5. The negative electrode tab lead 5 is formed of a similar material (described later) as the negative electrode current collector 21.

The negative electrode current collector 21 has a function of collecting current from the negative electrode active material layer. The negative electrode current collector 21 preferably includes at least one material having high conductivity. Examples of a highly conductive material include copper, nickel, and stainless steel. Examples of a shape of the negative electrode current collector 21 include a foil shape, a thin plate shape, a mesh shape, a nonwoven fabric shape, and a foam shape. A surface of the negative electrode current collector 21 may be roughened in order to enhance adhesion to the negative electrode active material layer.

The negative electrode active material layer contains, for example, a negative electrode active material and a solid electrolyte. The negative electrode active material layer is formed by applying a negative electrode slurry, which is generated by kneading the negative electrode active material and the solid electrolyte together with a dispersion medium, to the negative electrode current collector 21, and drying the negative electrode slurry. The dispersion medium includes a conductive assistant, a binder, and a solvent, and each material can be similar as that used in a general solid-state battery.

The negative electrode active material can be similar as that used for a negative electrode material of a general solid-state battery. Examples of the negative electrode active material include lithium metal, lithium alloys, silicon-based active materials such as Si and Si alloys, lithium transition metal oxides such as lithium titanate (Li₄Ti₅O₁₂), transition metal oxides such as TiO₂, Nb₂O₃ and WO₃, metal sulfides, metal nitrides, carbon materials such as graphite, soft carbon and hard carbon, and metallic indium.

The solid electrolyte contained in the negative electrode active material layer can be similar as that used in a general solid-state battery, and examples thereof include a similar solid electrolyte as the solid electrolyte (described later) contained in the solid electrolyte layer 30.

The solid electrolyte layer 30 is formed between the positive electrode layer 10 and the negative electrode layer 20. A material constituting the solid electrolyte layer 30 can be similar as that used for a solid electrolyte of a general solid-state battery, and examples thereof include a sulfide-based solid electrolyte material. The sulfide-based solid electrolyte material usually contains a metal element (M) serving as a conducting ion and sulfur(S). Examples of the M include Li, Na, K, Mg, and Ca, and among them, Li is preferable. In particular, the sulfide-based solid electrolyte material preferably contains Li, A (A is at least one selected from the group consisting of P, Si, Ge, Al, and B), and S, and among them, A is more preferably phosphorus (P). Further, the sulfide-based solid electrolyte material may contain halogen such as Cl, Br, or I. This is because ion conductivity is improved by containing halogen. The sulfide-based solid electrolyte material may contain O.

Examples of the sulfide-based solid electrolyte material having ion conductivity include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and Z is any of Ge, Zn, and Ga), Li₂S—GeS₂, Li₂S—SiS₂—Li₃PO₄, and Li₂S—SiS₂—LiₓQO_{y} (where x and y are positive numbers, and Q is any of P, Si, Ge, B, Al, Ga, and In). The description of “Li₂S—P₂S₅” means a sulfide-based solid electrolyte material using a raw material composition containing Li₂S and P₂S₅, and the same applies to other descriptions.

Other examples of the material constituting the solid electrolyte layer 30 include inorganic solid electrolytes such as an oxide solid electrolyte, a halide solid electrolyte, and a lithium-containing salt, and polymer-based solid electrolytes such as polyethylene oxide. As the material constituting the solid electrolyte layer 30, one type may be used, or two or more types may be used in combination.

The secondary battery 1 may further include an intermediate layer disposed between the negative electrode layer 20 and the solid electrolyte layer 30. For example, when the secondary battery 1 is a lithium metal secondary battery, the intermediate layer has a function of uniformly depositing a lithium metal. A material constituting the intermediate layer is not particularly limited, and examples thereof include a metal that can be alloyed with lithium and amorphous carbon.

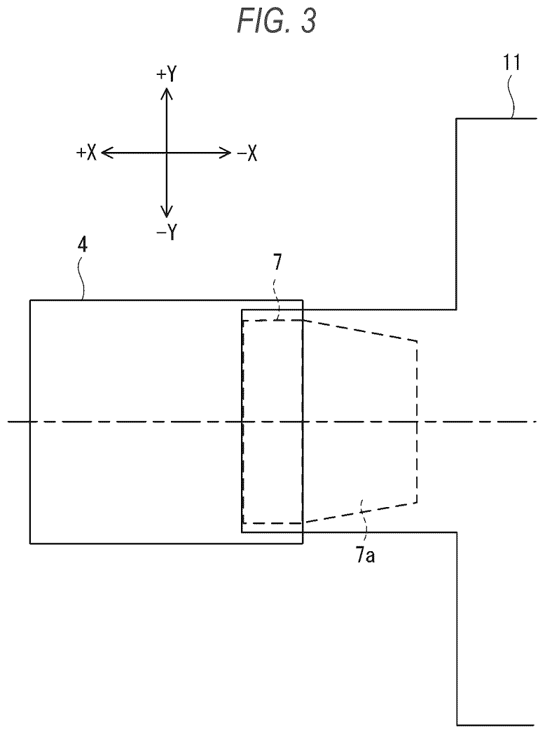

Next, connection between the plurality of positive electrode layers 10 and the positive electrode tab lead 4 will be described in detail with reference to FIGS. 2 and 3.

The positive electrode current collectors 11 of the plurality of positive electrode layers 10 extend from the electrode laminate 2 to the +X side, are bundled, and are joined to the positive electrode tab lead 4. The positive electrode current collector 11 is connected to a −X side end of the positive electrode tab lead 4.

In the present embodiment, the positive electrode current collectors 11 are connected to two surfaces of the positive electrode tab lead 4; The positive electrode current collector 11 disposed on a +Z side with respect to the positive electrode tab lead 4 is joined to a +Z side surface of the positive electrode tab lead 4, and the positive electrode current collector 11 disposed on a −Z side with respect to the positive electrode tab lead 4 is joined to a −Z side surface of the positive electrode tab lead 4.

In the present embodiment, between the positive electrode current collector 11 and the positive electrode tab lead 4, a resin member 7 capable of cutting off an overcurrent in accordance with an increase in temperature is provided. The resin member 7 is produced by mixing conductive particles such as carbon black or nickel with a polymer material. The resin member 7 is provided between the +Z side surface of the positive electrode tab lead 4 and the positive electrode current collector 11 disposed on the +Z side, and between the −Z side surface of the positive electrode tab lead 4 and the positive electrode current collector 11 disposed on the −Z side.

Thus, since the resin member 7 is provided between the positive electrode current collector 11 and the positive electrode tab lead 4, when an abnormality such as thermal runaway occurs and the secondary battery 1 reaches a high temperature, an overcurrent flowing due to charging and discharging of the secondary battery 1 can be cut off by the resin member 7. Therefore, safety of the secondary battery 1 can be improved.

The resin member 7 is, for example, an element having a positive temperature coefficient (PTC element). An electrical resistance value of the PTC element rapidly increases when a temperature exceeds a predetermined temperature (Curie temperature). In a normal state, the PTC element can be energized, but at a high temperature exceeding a predetermined temperature, the electrical resistance value of the PTC element rapidly increases, cutting off an overcurrent. Thus, by using the resin member 7 as the PTC element, a high current interruption effect can be ensured.

The positive electrode current collector 11, the resin member 7, and the positive electrode tab lead 4 are joined by ultrasonic joining. In the ultrasonic joining, since the positive electrode current collector 11, the resin member 7, and the positive electrode tab lead 4 can be joined in a solid state, an electrical influence at a joining portion at a room temperature can be reduced as compared with welding or the like. In addition, it is possible to sufficiently ensure adhesion in the joining portion.

The positive electrode current collector 11 has slack between the electrode laminate 2 and the positive electrode tab lead 4, and is loosened. Specifically, the positive electrode current collector 11 disposed on the +Z side is disposed to loosen on the +Z side, and the positive electrode current collector 11 disposed on the −Z side is disposed to loosen on the −Z side. Thus, since each positive electrode current collector 11 has the slack, even when the electrode laminate 2 expands and contracts, the positive electrode tab lead 4 can be prevented from being pulled by the positive electrode current collector 11 and displaced.

As described above, the positive electrode current collectors 11 are joined to the two surfaces of the positive electrode tab lead 4 via the resin member 7. With such a configuration, the number of positive electrode current collectors 11 in one joining location can be reduced as compared with a case where the positive electrode current collector 11 is joined to only one surface of the positive electrode tab lead 4. Therefore, the positive electrode current collector 11 and the positive electrode tab lead 4 can be favorably joined via the resin member 7.

The resin member 7 includes an extending portion 7a extending from the joining location with the positive electrode tab lead 4 toward the electrode laminate 2 (specifically, toward the −X side). The extending portion 7a restricts the positive electrode current collector 11 disposed on the +Z side from loosening toward the −Z side, and restricts the positive electrode current collector 11 disposed on the −Z side from loosening toward the +Z side. A length of the extending portion 7a is preferably, for example, half or more of a distance

between the positive electrode tab lead 4 and the electrode laminate 2.

Thus, since the resin member 7 includes the extending portion 7a, for example, when the electrode laminate 2 is sealed with the sheath 3, the positive electrode current collector 11 having the slack can be prevented as a whole from being biased to one side in the Z-axis direction with respect to the positive electrode tab lead 4. Specifically, it is possible to prevent both the positive electrode current collector 11 disposed on the +Z side and the positive electrode current collector 11 disposed on the −Z side from being loosened unevenly toward the −Z side (+Z side). Therefore, the positive electrode current collectors 11 can be disposed in a well-balanced manner with respect to the positive electrode tab lead 4.

The extending portion 7a of the resin member 7 has a shape in which a thickness decreases from the joining location toward a tip on the −X side. Accordingly, a weight of the resin member 7 can be reduced while preventing the positive electrode current collector 11 from being biased to one side in the Z-axis direction with respect to the positive electrode tab lead 4.

FIG. 3 illustrates the vicinity of the positive electrode tab lead 4 as viewed in the Z-axis direction. The extending portion 7a of the resin member 7 is provided at a central portion of the positive electrode current collector 11 in the Y-axis direction (width direction), and is not provided at an end on a +Y side and an end on the −Y side of the positive electrode current collector 11. Even with such a configuration, the weight of the resin member 7 can be reduced while preventing the positive electrode current collector 11 from being biased to one side in the Z-axis direction with respect to the positive electrode tab lead 4. In addition, since a contact region between the resin member 7 and the positive electrode current collector 11 can be reduced, an influence of unnecessary contact can be reduced.

A width of the extending portion 7a of the resin member 7 in the Y-axis direction decreases as the extending portion 7a extends in an extension direction (direction toward the −X side). Therefore, the weight of the resin member 7 can be further reduced while preventing the positive electrode current collector 11 from being biased to one side in the Z-axis direction with respect to the positive electrode tab lead 4.

Although an embodiment of the present disclosure has been described above with reference to the accompanying drawings, it is needless to say that the present invention is not limited to the embodiment. It is apparent to those skilled in the art that various changes or modifications can be conceived within the scope described in the claims, and it is understood that the changes or modifications naturally fall within the technical scope of the present invention. In addition, respective constituent elements in the above embodiment may be freely combined without departing from the gist of the invention.

For example, in the above-described embodiment, an example is illustrated in which the positive electrode current collector 11 is joined to the two surfaces of the positive electrode tab lead 4, but the present invention is not limited thereto. For example, the positive electrode current collector 11 may be joined to only one surface of the positive electrode tab lead 4. Even with such a configuration, the resin member 7 provided between the positive electrode tab lead 4 and the positive electrode current collector 11 can cut off the current flowing by charging and discharging of the secondary battery 1 when an abnormality such as thermal runaway occurs and the secondary battery 1 reaches a high temperature. Therefore, the safety of the secondary battery 1 can be improved.

In the above-described embodiment, an example in which the resin member 7 is provided between the positive electrode tab lead 4 and the positive electrode current collector 11 has been described, but the present invention is not limited thereto. For example, the resin member 7 may be provided between the negative electrode tab lead 5 and the negative electrode current collector 21. Specifically, the resin member 7 may be provided only between the negative electrode tab lead 5 and the negative electrode current collector 21, or the resin member 7 may be provided both between the positive electrode tab lead 4 and the positive electrode current collector 11 and between the negative electrode tab lead 5 and the negative electrode current collector 21.

In the present description, at least the following matters are described. In the parentheses, the corresponding constituent elements and the like in the above embodiments are shown as an example, but the present invention is not limited thereto.
(1 ) A secondary battery (secondary battery 1) including:
an electrode laminate (electrode laminate 2) in which a plurality of positive electrode layers (positive electrode layers 10) and a plurality of negative electrode layers (negative electrode layers 20) are laminated via an electrolyte layer (solid electrolyte layer 30); and
a sheath (sheath 3) that accommodates the electrode laminate, in which
a tab lead (positive electrode tab lead 4, negative electrode tab lead 5) protruding from the sheath is joined to a current collector of the positive electrode layers and a current collector of the negative electrode layers (positive electrode current collector 11, negative electrode current collector 21), and
a resin member (resin member 7) configured to cut off an overcurrent according to an increase in temperature is provided between the tab lead and at least one of the current collector of the positive electrode layers or the current collector of the negative electrode layers.

According to (1), since the resin member capable of cutting off an overcurrent in response to an increase in temperature is provided between the current collector and the tab lead, it is possible to cut off an overcurrent flowing due to charging and discharging of the secondary battery, for example, when a temperature of the secondary battery becomes high. Therefore, safety of the secondary battery can be improved.
(2 ) The secondary battery according to (1), in which
the resin member is a PTC element.

According to (2), since the resin member is the PTC element, an electrical resistance value of the PTC element increases when a temperature becomes high, so that a high current interruption effect can be ensured.
(3 ) The secondary battery according to (1) or (2), in which
the current collector, the resin member, and the tab lead are joined by ultrasonic joining.

According to (3), by joining the current collector, the resin member, and the tab lead by ultrasonic joining, it is possible to reduce an electrical influence at a room temperature in the joining portion. In addition, it is possible to increase adhesion in the joining portion.
(4) The secondary battery according to any one of (1) to (3), in which
the current collector is joined to two surfaces of the tab lead via the resin member.

According to (4), the number of current collectors in one joining location can be reduced by joining the current collector to the two surfaces of the tab lead, and thus the current collector and the tab lead can be favorably joined via the resin member.
(5) The secondary battery according to (4), in which
the resin member includes an extending portion (extending portion 7a) that extends from a joining location with the tab lead toward the electrode laminate.

According to (5), since the resin member includes the extending portion extending from the joining location with the tab lead toward the electrode laminate, the current collector can be prevented from being biased to one side in a thickness direction of the electrode laminate with respect to the tab lead. Therefore, the current collector can be disposed in a well-balanced manner with respect to the tab lead.
(6 ) The secondary battery according to (5), in which
the resin member is provided only at a central portion of the current collector to be joined in a width direction of the current collector.

According to (6), a weight of the resin member can be reduced as compared with a case where the resin member is provided up to an end of the current collector in the width direction. In addition, since a contact region between the resin member and the current collector can be reduced, an influence of unnecessary contact can be reduced.
(7) The secondary battery according to any one of (1) to (6), in which
the resin member is provided between the current collector of the positive electrode layers and the tab lead.

According to (7), since the resin member is provided on a positive electrode side, an overcurrent can be cut off on the positive electrode side, and safety is further improved.

What is claimed is:

1. A secondary battery comprising:
an electrode laminate in which a plurality of positive electrode layers and a plurality of negative electrode layers are laminated via an electrolyte layer; and
a sheath that accommodates the electrode laminate, wherein
a tab lead protruding from the sheath is joined to a current collector of the positive electrode layers and a current collector of the negative electrode layers, and
a resin member configured to cut off an overcurrent according to an increase in temperature is provided between the tab lead and at least one of the current collector of the positive electrode layers or the current collector of the negative electrode layers.

2. The secondary battery according to claim 1, wherein
the resin member is a PTC element.

3. The secondary battery according to claim 1, wherein
the current collector, the resin member, and the tab lead are joined by ultrasonic joining.

4. The secondary battery according to claim 1, wherein
the current collector is joined to two surfaces of the tab lead via the resin member.

5. The secondary battery according to claim 4, wherein
the resin member includes an extending portion that extends from a joining location with the tab lead toward the electrode laminate.

6. The secondary battery according to claim 5, wherein
the resin member is provided only at a central portion of the current collector to be joined in a width direction of the current collector.

7. The secondary battery according to claim 1, wherein
the resin member is provided between the current collector of the positive electrode layers and the tab lead.
